(19) United States
(12) Patent Application Publication
(10) Pub. No.: US 2026/0127623 A1
(43) Pub. Date: May 7, 2026

(54) SYSTEM TO CALCULATE COMPATIBILITY BETWEEN RESOURCE PROFILES

(71) Applicant: Oliver Siegel, Laguna Beach, CA (US)

(72) Inventor: Oliver Siegel, Laguna Beach, CA (US)

(21) Appl. No.: 18/935,611

(22) Filed: Nov. 3, 2024

(51) Int. Cl. G06Q 30/0201; G06F 40/30

(52) U.S. Cl. CPC G06Q 30/0201; G06F 40/30

(57) ABSTRACT

A system for creating resource profiles, the system comprising resource profiles having properties from a shared database of properties based on criteria from a semantic ontology in which the properties are classified as positive goals, negative problems, or transformative solutions. In addition to the system, a process to calculate match scores between resource profiles based on compatibility, the resource profiles comprised of properties that are classified from the semantic ontology. Furthermore, a system for storing resource profiles, the system comprising resource profiles and properties that describe the profiles from the semantic ontology and a match criteria table that sets forth instructions for match conditions between profile property pairings based on the semantic ontology.

### FIELD OF THE DISCLOSURE

This disclosure relates generally to a system that uses a semantic ontology to create pairings between available supply and demand resources and subsequently alerts are sent to resource owners and resource requesters when compatible matches between supplies and demands arise.

### BACKGROUND

In marketplaces, supply and demand allocation has increasingly relied on search algorithms designed to match providers with seekers. Decision makers are using social media platforms, dating apps, marketplaces, listings, and directory sites with keyword-based search engines to solve supply and demand problems. However, such systems often fall short of achieving true compatibility. A key challenge in the art is the convergence of matchmaking processes toward a limited number of highly optimized profiles, creating a “winner-takes-all” dynamic. This dynamic results in a market where a few profiles dominate, leaving many participants underutilized and dissatisfied. Current systems prioritize quantifiable factors like price, popularity, or ratings, amplifying the success of a small number of participants, while neglecting the potential value others might have to offer.

The challenge is further compounded by the relativity and quantifiability of value. Marketplace participants assign different values to the same item based on personal preferences and context, introducing complexity in resource allocation. For instance, an antique watch might be worth $10 to a pawn shop but $100,000 to a museum. Additionally, certain qualitative properties—such as emotional significance, rarity, or transformative potential—are difficult to measure but crucial for determining an item's true value.

Existing keyword-based search algorithms exacerbate this issue by focusing on sameness rather than compatibility, matching similar keywords instead of complimentary properties. Consequently, matchmaking processes on marketplaces often converge towards one optimal profile that performs best and that's in highest demand, creating high inequality and pyramid shaped markets with a few winners at the top, and many dissatisfied and underutilized participants at the bottom. Growing automation due to artificial intelligence (AI) technologies only amplifies this problem, particularly when these systems fail to provide transparent, explainable processes for the automated decisions they made. Many existing solutions further compound these existing problems, reduce diversity, and lead to cultural homogenization. Effective resource matching should involve deeper compatibility criteria that account for subjective preferences, contextual needs, and qualitative properties.

Accordingly, there exists a need in the art for an approach that uses compatibility criteria for effective resource matching that allows resource owners to receive alerts when their unique resources are requested by resource seekers, or when the specialized resources that they need become available. The presently disclosed system addresses this need.

### SUMMARY

The disclosure presented herein relates to a system for creating resource profiles, the system leveraging resource profiles with properties from a shared database of properties derived from a semantic ontology in which the properties are classified as positive goals, negative problems, or transformative solutions.

The system further has a match criteria table that sets forth instructions for match conditions derived from the semantic ontology.

The present disclosure further relates to a process to calculate match scores between resource profiles based on compatibility, the resource profiles containing properties derived from the semantic ontology in which the properties are classified as positive goals, negative problems, or transformative solutions.

Another aspect of the present disclosure is a system for storing resource profiles with properties derived from the semantic ontology that describe the profiles, and a match criteria table that sets forth instructions for match conditions between profile property pairings based on the semantic ontology.

Consumers of the system can upload demand profiles to a shared database, which constitutes the demand for resources.

What makes this system unique from traditional marketplaces, listings and directory sites, and keyword-based search engines with specific filters, is the ability to create resource profiles that characterize the subjective, non-quantifiable value of resources in unique and novel ways.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows the sematic ontology of negative problems, positive goals/desires, and transformative solutions.

FIG. 2 shows background information about techniques and principles that are commonly used in computer engineering.

FIG. 3 shows background information about concepts and ideas that factor into the subject matter of matchmaking and supply/demand allocation.

FIG. 4 shows diagrams to differentiate between subjective scenarios of supply and demand allocation using either sameness-based matching or compatibility-based matching.

FIG. 5 shows the semantic clarification of profile properties which enables more granularity and nuance in the matchmaking process.

FIG. 6 shows a complete overview of the presently disclosed system for optimal resource allocation.

FIG. 7 shows match criteria instructions with the semantic ontology.

FIG. 8 shows an exemplary database of properties with the semantic ontology.

FIG. 9 shows an example of property pairings for score calculation.

FIG. 10 shows an example of profile pairings with match scores.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The present description provides a system of matchmaking that provides information about the availability, similarity, and compatibility of different resources in ways that are currently not available in existing systems. The system provides alerts to resource owners when their resources are requested by resource seekers, as well as alerts to resource seekers when the specialized resources that they need become available.

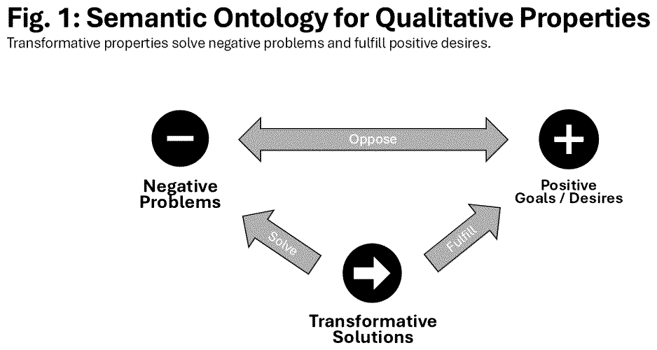

This system differs from traditional marketplaces, listings and directory sites, and keyword-based search engines with specific filters, in its ability to create resource profiles that characterize the subjective, non-quantifiable value of resources in unique ways. These ways are informed by and based on a specific semantic ontology (FIG. 1), that makes use of properties that are classified as positive goals, negative problems, and transformative solutions.

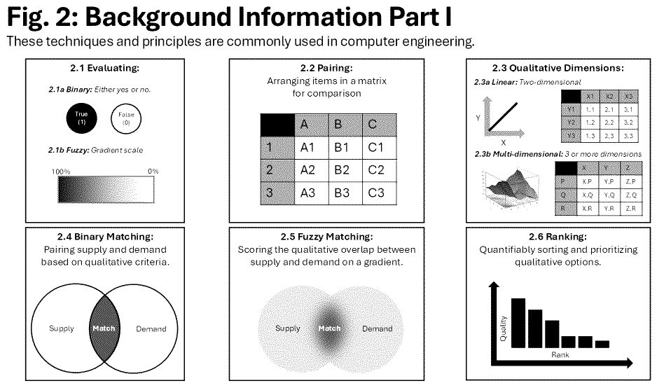

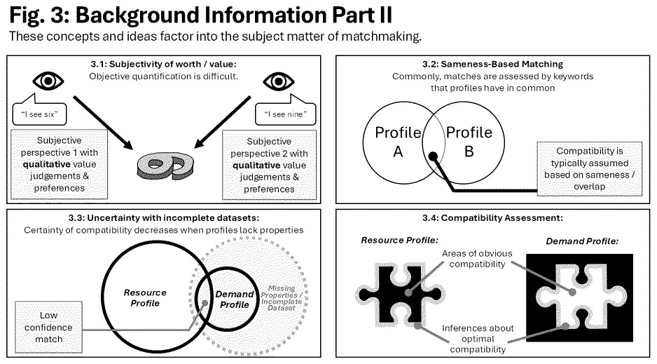

Traditional matching systems for allocation of resources between supply and demand typically focus on similarity to assess the relationship of supply and demand (FIG. 3.2). Referring to FIG. 2, such systems apply computer engineering and rely on evaluating supply and demand in either a binary sense, with a matching relationship as either true or false (FIG. 2.1a, FIG. 2.4), or alternatively, apply a fuzzy gradient scale ranging from 0% to 100% match (FIG. 2.1b, FIG. 2.5).

The evaluations are typically summarized from pairings by arranging items in a matrix for comparison (FIG. 2.2; FIG. 2.3), in which the matrix can be two dimensional (FIG. 2.3a) or multi-dimensional (FIG. 2.3b). Assigning quantifiable values to qualitative properties is a common technique used in computer engineering, which allows for an objective ranking and prioritizing of options (FIG. 2.6). The difficulty generally lies in deciding which quantifiable score to assign to which qualitative properties.

As seen in FIG. 3.3, profiles with larger, better-defined datasets will regard profiles with lesser defined datasets as less compatible in matchmaking scenarios. The basis for compatibility in such systems is typically asserted based on keywords that profiles have in common. In other words, compatibility is assumed based on sameness or a degree of overlap between two profiles (FIG. 3.2), which can also be termed a match between supply and demand. While such matching is often binary matching in nature, it can also be fuzzy matching, whereby scoring is done on a gradient between the qualitative overlap of supply and demand (FIG. 2.5).

This type of traditional matching system further involves applying a ranking system in which qualitative aspects or options are quantifiably sorted and prioritized, such as by a two-dimensional scale of match quality and where a match ranks (FIG. 2.2, FIG. 2.6).

Despite the utility of such traditional matching systems, there remains a need for optimization of matching systems. The worth or value of an item in these systems can be relative and/or subjective, such that quantifying the value raises concerns (FIG. 3.1). In this regard, two different perspectives that have differing qualitative value judgments and preferences can have a difficult task of objectively quantifying an item's value. In addition, such traditional matching systems tend to have pyramid shaped, winner takes all markets that converge on optimal profiles, leading to several problems such as wealth inequality, a sense of “the losers” being exploited, and underutilization of available resources. Furthermore, although it is given that supply must meet demand, how to define the outlines and boundaries of each is not always clear, which leads to inefficiencies of traditional matching systems (FIG. 3.4).

State-of-the-art technology is largely based on keyword search and machine learning from big data and provides matchmaking systems that are either too limiting and un-inclusive, or too unstructured, vague and broad. But even with advanced LLMs, it wouldn't be immediately obvious how to make inferences about any desirable “perfect match compatibilities”, due to the aforementioned subjective nature of value judgements. The structured approach outlined by our solution is required to prompt LLMs or other AI systems to make good decisions about compatibility between resources.

Given the issues with existing, traditional matching systems, there remains a need for a more optimal system of matching for calculating compatibility and creating mutually beneficial win-win scenarios.

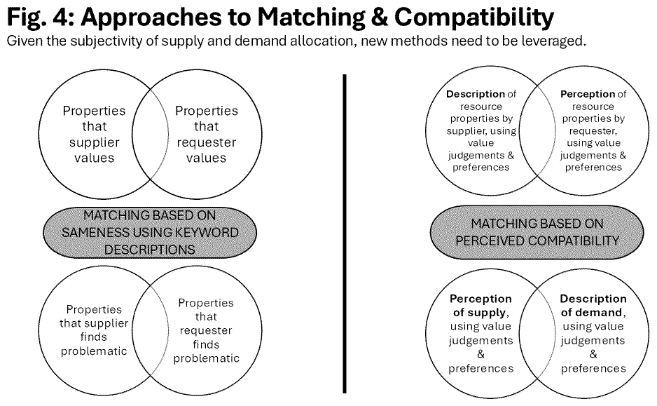

As described herein, the presently disclosed system utilizes matching based on compatibility rather than the traditional approach of matching based on sameness. As shown in FIG. 4, matching based on sameness detects matches as overlaps between properties that suppliers value and properties that requesters value, as well as properties that supplies and requesters find problematic. In contrast, the presently disclosed system uses matching based on the compatibility of properties that appear dissimilar on the surface but are synergistic in the context of supply and demand allocation. In this approach, an overlapping match occurs between a description of resource properties by a supplier, using value judgements as well as preferences, and a perception of resource properties by a requester, using value judgements and preferences. Furthermore, matching based on compatibility involves determining matches between a perception of supply, using value judgements as well as preferences, and a description of demand, using value judgements and preferences.

The presently described system based on a semantic ontology for qualitative properties addresses this need. In particular, the semantic ontology regards resources in terms of problems, goals and solutions, which can also be referred to as negative problems, positive goals/desires, and transformative solutions (FIG. 1). In this semantic ontology, negative problems oppose positive goals/desires. Transformative solutions solve negative problems and fulfill positive goals/desires (FIG. 1).

The system described herein includes instances of qualitative properties that are classified into one of three different categories, which include: 1) positive goals/desires (or terminal goals); 2) negative problems (or violated terminal goals); and 3) transformative solutions (or instrumental goals). In particular, positive goals/desires include descriptions of abstract, emotional aspirations, needs, desires, wishes, interests, and other instances of wanted objectives. Conventionally, these positive properties are considered to have intrinsic value and are consequently referred to as “terminal goals”. Negative problems/violated terminal goals include descriptions of difficulties, issues, challenges, obstacles, pain points, or other instances of negative consequences or objections. Transformative solutions include descriptions of specific, tangible, actionable, transformative traits and other useful characteristics that solve problems and fulfill terminal goals. Conventionally, these transformative properties are considered to be the means to an end, and they are consequently referred to as “instrumental goals” because they are thought to have instrumental value.

The need for a more granular semantic ontology becomes apparent when examining the linguistic meaning of the words positive and negative in the context of supply and demand.

As used herein with respect to supply and demand profiles and their properties, “positive” can mean desirable, and also present, in existence, or in possession. The term “negative” can mean undesirable and also lacking or unavailable. However, when an item is desired but lacking, it is ambivalently positive and negative, thus leading to confusion or difficulty.

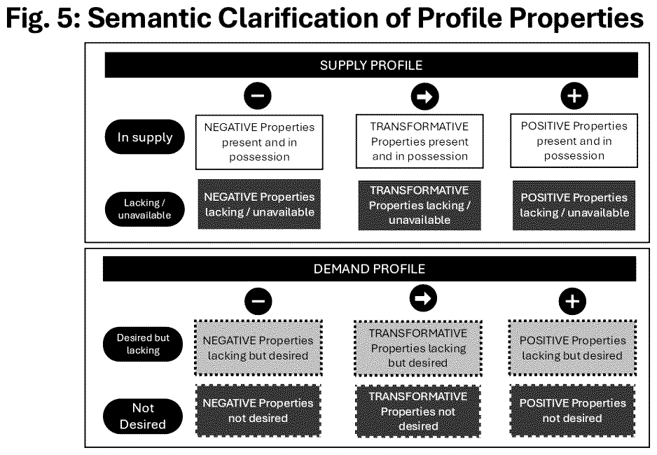

The presently described system enables supply profiles to have at least six categories for their properties, derived from positive (1), negative (2), and transformative (3), as well as in supply (a) and lacking (b). Likewise, demand profiles may have six categories for their properties, derived from positive (1), negative (2), and transformative (3), as well as desired but lacking (c) and undesirable (d). Accordingly, this scenario would create six categories of properties for each type of profile (for each of supply and demand profiles) and thus provide more semantic nuance for describing supply and demand profiles (FIG. 5).

Given the six categories of properties for both supply and demand profiles, when the properties of profile pairings are arranged in a matrix and compared for match or mismatch, the presently described configuration of the system can create 36 unique points of evaluation per profile pairing. Each point of evaluation creates a unique query into compatibility, thus providing a deep and rich dataset about the quality of a match. Using this system, queries can be standardized and answered by large language models (LLMs) or other intelligent computer systems.

These classifications allow for a more granular approach to matching supply with demand. Rather than relying on surface-level similarities, this system quantifies the compatibility between supply and demand profiles by evaluating not only the availability and desirability of resources but also their transformative potential. A shared database of resource profiles can populate these categories, providing deeper, more nuanced compatibility scores.

By introducing a system that captures the full spectrum of supply and demand profiles in terms of their properties—including positive, negative, and transformative factors—this system improves resource allocation efficiency and ensures a more equitable and effective marketplace. The system provides a solution to the existing shortcomings in keyword-based matching algorithms and creates pairings that better reflect the diverse and relative values that marketplace participants assign to resources.

The system provided herein allows resource owners to upload resource profiles to a shared database, which constitutes the supply of resources.

Consumers of the system can upload demand profiles to a shared database, which constitutes the demand for resources.

The supply and demand pool of profiles share a common database of properties. This database of properties utilizes the above-referenced semantic ontology, comprised of a problem-goal-solution classification. This problem-goal-solution classification categorizes qualitative properties in three interconnected dimensions. The system thereby provides a unique method of characterizing qualitative traits and using them to describe resource profiles and demand profiles for resources.

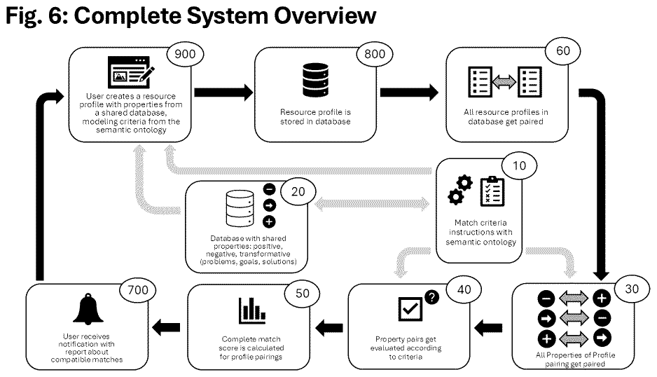

Turning to FIG. 6, a complete overview of the presently described system is provided. Per the overview, at 900, a user creates a resource profile with properties from a shared database (20), modeling criteria from the semantic ontology. In summary, the shared database 20 has shared properties: positive, negative, transformative (problems, goals, and solutions). The shared database 20 incorporates match criteria instructions with the semantic ontology (10), as detailed more fully below. The resource profile created by the user at 900 is stored in a database (800). To assess compatibility, all resource profiles in the database are paired (60). All properties of the paired profiles (60) are in turn paired (30). The property pairings (30) are next evaluated according to the match criteria (40). Then, a complete match score for the profile pairings is calculated (50). Next, the user receives notification with a report about compatible matches (700). Likewise, different users that have created a resource profile (at 900) receive notification of the report about compatible matches (700) to the extent such a report is useful to a particular user. For example, a first user who has created a supply profile at 900 might fulfill a demand profile created by another user at 900.

The match criteria/instructions with the semantic ontology (10) is central to the presently described system, as it informs the system and informs how pairings are made between properties and values. The semantic ontology provides a general formula for the system that can be applied for virtually all types of situations and sets forth the database schema/architecture. As a result, the match criteria sets forth lists and properties that take the same general format.

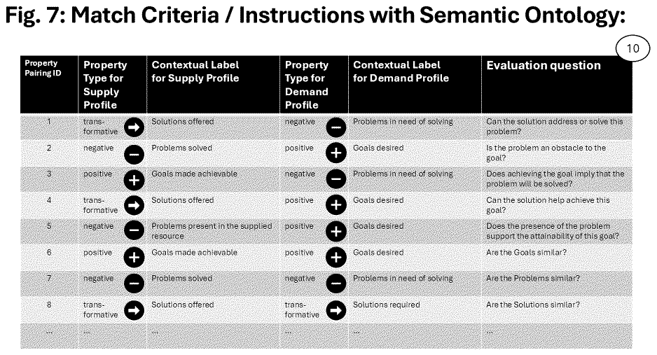

An example of the match criteria/instructions with the semantic ontology (10) is shown in the table 10 displayed in FIG. 7. This table is an exemplary configuration table for a computerized system, with property pairing IDs. The table 10 also includes the defined property types of the semantic ontology for supply and demand profiles: negative, positive, and transformative. The contextual labels included in the table associate with the supply and demand profiles and characterize the use of the property in a matchmaking scenario. The evaluation question is used to evaluate whether the property pairings of supply and demand profiles are a match or mismatch. The table sets forth instructions for match conditions for a process that can be automated by the use of large language models (LLMs) or similar intelligent systems. The table 10 therefore gives instructions for the system to interface with the matching process.

The match criteria/instructions with the semantic ontology as shown in FIG. 7 provides a number of examples of instructions based on property pairings from different profiles. These property pairings include but are not limited to: transformative and negative (ID 1); negative and positive (ID 2); positive and negative (ID 3); transformative and positive (ID 4); negative and positive (ID 5); positive and positive (ID 6); negative and negative (ID 7); and transformative and transformative (ID 8).

The property pairings of FIG. 7 are associated with the supply and demand profiles listed in the table. These supply and demand profiles include, but are not limited to: solutions offered and problems in need of solving (ID 1); problems solved and goals desired (ID 2); goals made achievable and problems in need of solving (ID 3); solutions offered and goals desired (ID 4); problems present in the supplied resource and goals desired (ID 5); goals made achievable and goals desired (ID 6); problems solved and problems in need of solving (ID 7); solutions offered and solutions required (ID 8).

Against this backdrop, specifics provided by the match criteria/instructions with semantic ontology in the table of FIG. 7 can be examined. Property pairing ID 1 shows instructions for a transformative property type contextualized as “solutions offered” by a supply profile which is paired with a negative property type from a demand profile, contextualized as “problems in need of solving”. The evaluation question in this instance is “Can the solution address or solve this problem?”.

Property pairing ID 2 shows instructions for a negative property type contextualized as “problems solved” by a supply profile which is paired with a positive property type from a demand profile, contextualized as “goals desired”. The evaluation question in this instance is “Is the problem an obstacle to the goal?”.

The remaining property pairing IDs 3-8 in FIG. 7 show additional instructions for pairing property types of supply profiles with property types of demand profiles and the evaluation questions associated with the respective pairings. The match criteria instructions in the table 10 of FIG. 7 are illustrative of the type of match criteria instructions per the semantic ontology but is not exhaustive. Other match criteria instructions that apply the principles of the semantic ontology are also contemplated by the presently described matching system and process.

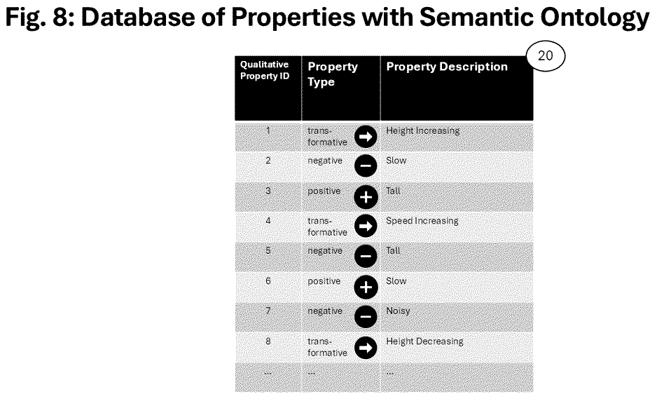

The match criteria instructions in 10 (FIG. 7 and FIG. 6) apply to the database with shared properties 20 (FIG. 8 and FIG. 6). According to the semantic ontology of properties, given properties are either negative, positive, or transformative, which are also respectively referred to as problems, goals, and solutions.

A simplified, exemplary database (20) of properties with the semantic ontology is shown in FIG. 8. In this exemplary database (20) 8 property IDs (1-8) are listed by property type (negative, positive, or transformative) along with a property description. In this simplified example, property descriptions relate to various attributes of property types, including: slow; tall; height increasing; height decreasing; speed increasing; and noisy. The context of a given property type can influence the property description. In this example, a negative property type carries a slow property description, while a positive property type also carries a slow property description. In the context of the negative property type, the slow aspect is a detractor, while in the context of the positive property type, the slow aspect is advantageous. The system therefore provides flexibility with respect to property types and their descriptions. Furthermore, the system is malleable, such that property types and their descriptions can be added over time as the database increases or is modified and becomes better informed.

Given the semantic ontology and how it is applied, the presently disclosed matching system creates profile pairings, which are based on the various properties of the profiles. The basic question that this system seeks to answer is how it is known if there is a match or mismatch between resource profiles? Whether or not there is a match is derived from a score calculation from property pairings. All properties of profile pairings are themselves paired at 30 (FIG. 6). The property pairs are then evaluated (40) according to match criteria instructions 10 (FIG. 6).

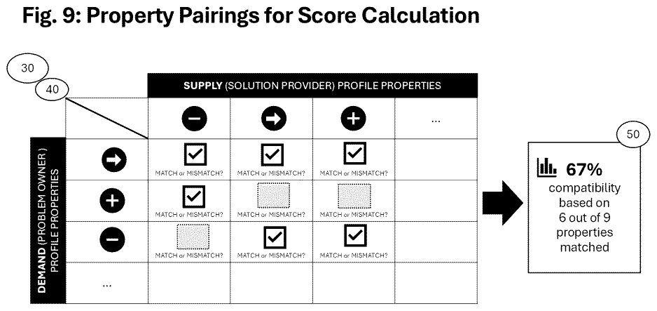

An exemplary score calculation from property pairings is shown in FIG. 9. In this example, the properties of a demand profile are compared to the properties of a supply profile. The demand profile can be regarded as that of a problem owner, while the supply profile can be regarded as that of a solution provider. Application of the semantic ontology in this example involves matching of the transformative solutions, positive goals/desires, and negative problems of each of the profiles. The matching raises the question of whether there is a match or mismatch between each of the property types. In this example, there is a 67% compatibility between the demand and supply profiles based on matching of six out of nine properties. Accordingly, the process of pairing profiles (30) and evaluating the pairings per the match criteria instructions (40) resulted in a complete match score being calculated for the profile pairings (50) (see FIGS. 9 and 6).

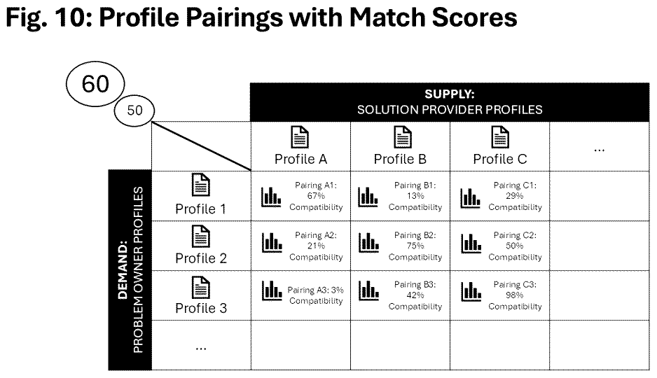

In summary, all of the profiles are paired in the system (at 60 in FIG. 6,) and a score is calculated for the matching compatibility (at 50 in FIG. 6) via the process captured at 30 and 40 (FIGS. 6 and 9). Applying this basic approach for each of the demand and supply profiles creates a significant complexity as all of the paired properties of the paired supply and demand profiles are calculated. A simplified example of profile pairings with match scores is shown in FIG. 10 via the process captured at 60 and 50. In this example, three demand profiles (1, 2, and 3) are matched with three solution provider files (A, B, and C). The wide range of compatibility percentages demonstrates the utility of completely pairing profile properties and providing comprehensive pairings. These pairings allow for meaningful compatibility matching that could be overlooked or missed with traditional matching systems.

Once the system has analyzed the entire database, the resource profile owner and demand profile owner may receive notifications, alerts, or reports about the findings (at 700 in FIG. 6).

As outlined above, the presently disclosed system is unique from traditional marketplaces, listings and directory sites, and keyword-based search engines with specific filters. In particular, the present system has the ability to create resource profiles that characterize the subjective, non-quantifiable value of resources in unique manners via the semantic ontology.

As resource owners update their resource supply profiles and resource seekers update their demand profiles, an automated computer system will pair the profiles in a matrix for comparison. This pairing and comparison allows the profile's properties to be also paired in a second matrix, and their compatibility can be calculated. Reports will then be generated for either party about the quality of matches that have been found.

The demand profiles created by users outline the non-quantifiable properties that they are searching. Accordingly, a demand profile can be regarded as effectively a resource profile in reverse.

Resource profiles and demand profiles have several lists of qualitative properties that are each comprised of terminal goals, instrumental goals, or violated terminal goals (problems, needs and values, and solutions). Resource profiles and demand profiles also contain anti-qualities, which

allow to set boundaries on the qualitative and unquantifiable properties of the resource.

With this straightforward classification system, resources and the demand for resources can be compared for similarity and for compatibility across multiple dimensions.

The shared database of properties, which contains the qualitative properties characterized with the problem-goal-solution classification, can be ever expanding while still remaining human readable and understandable. Therefore, this resource inventory and matchmaking system will stay updated even when changing trends, sentiments, and preferences alter the meaning of what constitutes a “valuable” resource. At the same time, this system allows these trends to be documented over time, permitting a deeper analysis of what qualitative aspects of resources have been valued historically.

Comparing resources for similarity (using percentage points or scores) gives more transparency in the marketplace. Furthermore, traits and characteristics that were previously difficult to quantify can now become a metric. While “uniqueness” of a resource may otherwise be difficult to quantify, with this inventory of resource profiles the level of homogeneity in the supply and demand pools can be reported.

While current, traditional matchmaking systems usually provide information about surface-level similarity and sameness (or “things in common”), the problem-goal-solution classification allows implicit inferences to be made about deeper compatibilities that are not immediately obvious.

The system described herein further includes resource profiles whereby each resource profile has distinct lists of contextualized properties. These distinct lists of contextualized properties include but are not limited to: lists of qualitative properties offered; lists of anti-qualities that negatively characterize this resource; lists of quantifiable traits; and lists of properties that don't fall under the problem-goal-solution classification. In particular, lists of qualitative properties offered include but are not limited to: a) solutions offered and goals fulfilled by this resource; b) problems solved, obstacles overcome, and violations to terminal goals alleviated by this resource; and c) needs, desires, positive values and terminal goals fulfilled by this resource. Likewise, lists of anti-qualities that negatively characterize this resource include but are not limited to: a) terminal goals and instrumental goals that this resource can't fulfill; and b) problems that are perceived with this resource.

The system described herein also includes distinct lists of properties, that include but are not limited to: 1) lists of qualitative properties requested from an ideal resource; 2) lists of anti-qualities that disqualify potential resources; 3) lists of quantifiable properties requested from an ideal resource, expressed as a range; and 4) lists of desired properties that don't fall under the problem-goal-solution classification. In particular, lists of qualitative properties requested from an ideal resource include: a) solutions required and goals currently unfulfilled; b) unsolved problems; present obstacles; and violations to terminal goals currently in need of being alleviated; and c) needs; desires; positive values; and terminal goals wanted but that are currently unfulfilled. The lists of anti-qualities that disqualified potential resources include: dealbreaker properties that may be incorrectly considered a good match but shouldn't be treated as such because they would lead to rejection.

The system described herein includes a matchmaking process, as described above and outlined in FIG. 6. In particular (at 60 in FIG. 6), 1) each supply profile will be paired with a demand profile, generating a “paired instance.” Next, 2) the paired instance is the starting point for a sub-process to compare the properties of each paired profile with the properties of the other paired profile, creating property pairings (at 30 in FIG. 6). In a further step (at 40 in FIG. 6), 3) each property pairing is evaluated for compatibility and similarity, based on the type of property (problem/goal/solution) and based on the location of the property on the resource profile (which qualitative property list the property was listed under). This process is complex, but logically flows from the description given.

Examples of evaluation questions to calculate compatibility scores include: how many of the problems listed by the demand profile does the resource profile indicate that it is solving? If 10 problems were listed on the demand side, and 5 solutions on the supply side, and 3 of the solutions actually solve the problem, then the resource is a 30% match for the demand in the problem/solution property pairing.

Another example: how many of the terminal goals listed by the demand profile does the resource profile indicate that it is fulfilling via solution-properties? If 10 terminal goals were listed on the demand side, and 4 solutions on the supply side, and 2 of the solutions actually fulfill the terminal goal, then the resource is a 20% match for the demand in the terminal goal/solution property pairing.

Within the system, various other property pairings may contribute toward different aspects of compatibility scores or match scores. For example: 1) similarity percentage due to sameness and overlap; 2) friction score due to anti-quality collisions; 3) implicit alignment calculated from inferences that can only be made with the semantic ontology to classify properties; and 4) uncertainty percentage or “surprise factor” due to size differences of the data sets or gaps in the data sets.

In the system, after evaluating each of the property pairings, an average match score may be calculated and displayed as one comprehensive score on the profiles (at 50 in FIG. 6 and as further detailed in FIG. 9 and FIG. 10).

Finally, once the system has analyzed the entire database, the resource profile owner and demand profile owner may receive notifications, alerts, or reports about the findings (at 700 in FIG. 6).

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The exemplary, preferred embodiment was chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

While the system is designed to generally cover any matchmaking scenarios where supply profiles and demand profiles need to be paired, it is possible to use this system in creative manners and apply it to various scenarios where traditional marketplaces and keyword-based search engines may fall short.

### Example I: Luxury Goods and Collectibles (Auction and Sales Platforms)

Scenario: A platform specializing in luxury goods and collectibles-such as vintage cars, rare watches, and fine art-needs to match sellers with buyers who have unique value perceptions. Traditional platforms typically prioritize the highest bidder, overlooking nuanced factors that may be more meaningful to both parties. This system enhances compatibility by considering the emotional and historical resonance a buyer may have with an item, rather than focusing solely on monetary value.

How This System Works: The compatibility scoring system evaluates profiles to capture both practical and emotional values:

Supply Profile (Luxury Item): Could include factors like condition, rarity, historical significance, and market availability. For example, a seller might list an item as having a “rusty” or “aged” appearance, which they might initially see as a flaw.

Demand Profile (Buyer): Could capture the buyer's specific aesthetic preferences, sentimental interest, and investment potential. For instance, a buyer looking for a rugged, vintage look may see the “rusty” condition as a positive attribute, making them a perfect match for an item with such characteristics.

By considering these qualitative factors, the system can identify buyers who value an item for its uniqueness or history rather than just market value, ensuring a more meaningful transaction. For example, a buyer who has a personal connection to a particular era or artist (positive and desired) may be matched with a seller who prefers their item to go to an appreciative custodian rather than the highest bidder.

Compatibility scores: the platform can apply tailored compatibility scores to highlight matches that are mutually fulfilling, including:
1) Custodianship Score: Assessing the buyer's likelihood of appreciating and caring for the item as a long-term investment or collectible.
2) Aesthetic Alignment Score: Matching the buyer's stylistic preferences with item traits often considered flaws, like patina or wear, which are actually desirable in this context.
3) Sentimental Value Score: Measuring the buyer's emotional or historical connection to the item's origin, brand, or style.

This compatibility system transforms the buying and selling process into a win-win transaction, emphasizing value beyond price. This approach can also solve the “old watch in a pawn shop vs. in a museum” dilemma by pairing each item with a buyer who truly appreciates its unique character.

### Example II: Sustainability and Circular Economy (Resource Sharing)

Scenario: A circular economy platform connects companies looking to repurpose waste materials (like scrap metal or unused chemicals) with manufacturers or artists who could use them. Traditional systems often rely on simple availability listings without understanding compatibility in terms of resource needs.

How This System Works: The platform matches resources using the proposed compatibility scoring system: Supply Profile (Scrap Materials Provider): Includes the type of materials, quantity, and transformative potential (e.g., materials that could be upcycled or modified for creative uses).

Demand Profile (Manufacturer or Artist): Includes desired materials (positive & desired), materials to avoid due to environmental impact (negative & not desired), and willingness to transform raw materials into new products (transformative & desired).

By recognizing the transformative potential of certain materials, the platform helps users find win-win matches. For example, a waste product might be negative for a landfill but transformative for an artist, thus creating a new value stream.

### Example III: Dating & Romance Platforms

Scenario: In a matchmaking platform where users seek romantic partners, traditional systems often rely on general attributes (e.g., interests, hobbies, life goals). However, many personal traits that may be seen as weaknesses or shortcomings by some could be perceived as desirable by others. This platform can use the compatibility scoring system to assess complex emotional dynamics, allowing for matches that embrace and even celebrate these perceived “flaws” as unique points of attraction.

How This System Works: The compatibility scoring system evaluates both partners' profiles to identify deeper personal traits:

Supply Profile (Individual's Traits): Could include characteristics like obsessiveness, emotional distance, dominance, shyness, or unpredictability.

Demand Profile (Partner's Preferences): Includes traits they are drawn to, as well as negative traits to avoid. These profiles can reflect both conscious preferences and unconscious compatibilities, creating a nuanced match beyond surface-level attributes.

Example Profile Properties could include characteristics such as: Obsessive and clingy; Cold, distant, and avoidant; Aggressive and dominant; Shy and submissive; Calm and calculated to the point of predictability; Irrational and emotionally volatile; Overly confident or a know-it-all; and Often lost or disoriented.

By pairing users based on these “shadow” traits and allowing for “growth potential,” the system creates matches that are both satisfying and offer potential for personal development. Compatibility is based on unique attraction dynamics, where one partner's perceived weakness may be another's preferred trait, leading to a win-win match.

Compatibility Scores: To reflect the complex emotional and psychological dimensions, the system could generate unconventional compatibility metrics to suggest matches that not only satisfy attraction but also foster emotional growth. For example: a Growth-Potential Score, a Trauma Compatibility Percentage, or a Shadow Alignment Score. Additionally, Friction Scores could identify potential areas of conflict, highlighting anti-traits that may clash or align with a user's boundaries. This scoring method provides a holistic view of compatibility by balancing both desired and potentially challenging traits, thus facilitating more meaningful connections

### Example IV: Job Marketplaces (Hiring Platforms)

Scenario: A hiring platform needs to match job seekers with employers. Traditional systems rank candidates based on qualifications and keywords (e.g., job titles, degrees, skills), often resulting in many applicants applying for a small number of popular jobs, leaving others underutilized.

How This System Works: The compatibility scoring system would evaluate both employers and job seekers based on deeper criteria: Supply Profile (Job Seeker): Could include qualifications, availability, willingness to relocate, and transformative potential (e.g., how a candidate's skill set could adapt to a different role).

Demand Profile (Employer): Could include desired skills, willingness to train, team culture fit, or an openness to non-traditional qualifications.

By considering positive, negative, and transformative factors (e.g., a candidate's willingness to learn a new skill could be transformative for the role), the platform could match candidates and companies in ways that go beyond simple keyword matches. For example, a candidate lacking certain technical skills (negative) but demonstrating adaptability (transformative) could be matched with an employer willing to invest in training (transformative but desired).

### Example V: Shared Office Spaces (Real Estate or Coworking Platforms)

Scenario: A coworking space provider is trying to match available office space with businesses or freelancers looking for a work environment. Traditional matching may be based on location, square footage, and price alone.

How This System Works: The platform uses this compatibility scoring system to evaluate deeper preferences: Supply Profile (Coworking Space): Could include amenities offered (e.g., quiet areas, collaboration zones, 24-hour access), size, location, unique transformative characteristics (e.g., spaces tailored to tech startups or creative industries), and other qualitative properties such as small and cozy or open and spacious.

Demand Profile (Business or Freelancer): Could include specific needs (e.g., quiet work environment, networking opportunities) or negative factors they want to avoid (e.g., busy areas, high costs).

By analyzing these factors, the platform could recommend spaces where the available supply transforms the work experience, not just providing a physical space but creating a more tailored environment (e.g., a creative space that enhances productivity and collaboration).

### Example VI: Education and Skills Training

Scenario: An online learning platform needs to match learners with courses or skill training. Traditional systems often match learners to courses based on predefined categories, like subject or difficulty level, but fail to capture individual learning styles or goals.

How This System Works: The platform assesses deeper compatibility: Supply Profile (Course or Training Program): Could include course topics, teaching methods (interactive, lecture-based), and transformative potential (e.g., a beginner-level course that opens doors to advanced topics).

Demand Profile (Learner): Could include current skill level, learning preferences, and negative factors to avoid (e.g., lack of hands-on experience or outdated teaching methods).

The compatibility system would match learners not just based on subject matter but on how a course could transform their skill set in meaningful ways. For example, a course that lacks hands-on experience (negative) might be avoided by one learner but sought after by another who needs only theoretical knowledge (positive).

### Example VII: Healthcare Services (Telemedicine or Specialist Matching)

Scenario: A telemedicine platform needs to match patients with specialists based on a wide range of needs, but the system must also consider patient preferences, treatment styles, and the transformative potential of certain therapies.

How This System Works: Compatibility scores help create better patient-specialist matches:

Supply Profile (Healthcare Provider): Includes services offered (e.g., general care, specialized procedures), treatment philosophy (e.g., holistic, traditional), and transformative potential (e.g., willingness to adopt cutting-edge therapies).

Demand Profile (Patient): Includes desired treatment approaches (positive & desired), past negative experiences (negative & not desired), and willingness to undergo transformative treatments.

The system could match a patient who prefers holistic methods (positive and desired) with a provider specializing in those, avoiding specialists who focus on treatments the patient dislikes (negative and not desired), while also considering whether new therapies could be transformative for the patient's condition.

What is claimed is:

1. A system for creating resource profiles, the system comprising resource profiles having properties from a shared database of properties based on criteria derived from a semantic ontology, wherein the properties are classified as positive goals, negative problems, or transformative solutions.

2. The system of claim 1 further comprising a match criteria table that sets forth instructions for match conditions from the semantic ontology of properties classified as positive goals, negative problems, or transformative solutions.

3. The match criteria table of claim 2, the match criteria table comprised of a field to select a positive, negative, or transformative property and a label field to contextualize the use of the property for describing a resource profile to model criteria from the semantic ontology.

4. The match criteria table of claim 2, the match criteria table comprised of fields to configure property type pairings and evaluation questions to assess whether the property pairings between resource profiles are a match or mismatch.

5. The system of claim 1, further comprising a database with supply and demand profiles that model criteria from a semantic ontology comprised of properties that are classified as positive, negative, or transformative.

6. The system of claim 5, further comprising a process of pairing the supply and demand profiles and assessing compatibility by calculating a match score for each profile pairing in the database.

7. The process of claim 6 comprising a subprocess that pairs all resource profiles in the database and then pairs properties of the paired profiles according to a match criteria table that sets forth instructions for match conditions from the semantic ontology of properties classified as positive goals, negative problems, or transformative solutions.

8. The process of claim 7 further comprising a process that evaluates the property pairings and calculates a match score for each profile pairing in the database according to the match criteria table by counting the number of matched and unmatched property pairings of each profile pairing and providing a quantifiable metric to indicate the match score between profile pairings.

9. The process of claim 8, in which the quantifiable metric is a ratio or a percentage match score between profile pairings.

10. The system of claim 8 further comprising a process to send users notifications with a report of compatible matches based on match scores between profile pairings.

11. A process to calculate match scores between resource profiles based on compatibility, the resource profiles comprised of properties that are classified from a semantic ontology as positive goals, negative problems, or transformative solutions.

12. The process of claim 11 further comprising a match criteria table that sets forth instructions for match conditions from the semantic ontology comprised of properties that are classified as positive goals, negative problems, or transformative solutions.

13. The match criteria table of claim 12, the match criteria table comprising a field to select a positive, negative, or transformative property and a label field to contextualize the use of the property for describing a resource profile according to criteria from the semantic ontology.

14. The match criteria table of claim 12, the match criteria table comprising fields to configure property type pairings and evaluation questions to assess whether the property pairings between resource profiles are a match or mismatch.

15. The process of claim 11, wherein the resource profiles are contained in a database comprised of supply and demand profiles modeling criteria from a semantic ontology in which profile properties are classified as positive goals, negative problems, or transformative solutions.

16. The process of claim 14 further comprising a process to assess compatibility by calculating a match score for each profile pairing in the database.

17. The process of claim 16 further comprising a subprocess that pairs all resource profiles in the database and then pairs the properties of the paired profiles according to a match criteria table that sets forth instructions for match conditions from the semantic ontology comprised of properties that are classified as positive goals, negative problems, or transformative solutions.

18. The process of claim 16 further comprising a process that evaluates the property pairings and calculates a match score for each profile pair in the database according to the match criteria table that sets forth instructions for match conditions from the semantic ontology comprised of properties that are classified as positive goals, negative problems, or transformative solutions, the match score calculated by counting the number of matched property pairs of each profile pairing.

19. A system for storing resource profiles, the system comprising resource profiles and properties that describe the profiles from a semantic ontology that classifies the properties as positive goals, negative problems, or transformative solutions, and a match criteria table that sets forth instructions for match conditions between profile property pairings based on the semantic ontology.

20. The system of claim 19, the match criteria table comprising fields to select a positive, negative, or transformative property and a label field to contextualize the use of the property that describes a resource profile to model criteria from the semantic ontology, and fields to configure property type pairings and evaluation questions to assess whether the property pairings used to describe the resource profiles are a match or mismatch.
